(19) United States
(12) Patent Application Publication
(10) Pub. No.: US 2009/0122944 A1
(43) Pub. Date: May 14, 2009

(54) FAST BREEDER REACTOR TYPE NUCLEAR POWER PLANT SYSTEM

(76) Inventors: Koji Namba, Mito (JP); Koji Fujimura, Hitachinaka (JP); Satoshi Itooka, Hitachi (JP); Kazuhiro Fujimata, Kasama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/190,795

(22) Filed: Aug. 13, 2008

(30) Foreign Application Priority Data
Sep. 27, 2007 (JP) 2007-252106
May 28, 2008 (JP) 2008-139737

(51) Int. Cl. G21C 15/00

(52) U.S. Cl. 376/402

(57) ABSTRACT

A fast breeder reactor type nuclear power plant system including a reactor vessel provided with a core and a pipe of primary loop coolant for supplying primary loop coolant to the reactor vessel.

One or more bending parts are formed on at least the pipe of primary loop coolant of the pipes, and a part of the bending part on a downstream side is provided with a flow path having a non-circular sectional configuration wherein the negative side of the bending part is formed in either a planar or flat shape.

### CLAIM OF PRIORITY

The present application claims priority from Japanese Patent application serial no. 2007-252106, filed on Sep. 27, 2007 and Japanese Patent application serial no. 2008-139737, filed on May 28, 2008, the content of which is hereby incorporated by reference into this application.

### BACKGROUND OF THE INVENTION

The present invention relates to a fast breeder reactor type nuclear power plant system, and more particularly, to the configuration for routing a pipe such as a pipe of primary loop coolant, pipe of secondary loop coolant and pipe of feed water and main steam, and to the sectional configuration of the flow paths of various pipes in the fast breeder reactor type nuclear power plant system.

As a conventional nuclear power plant system, a fast breeder reactor type nuclear power plant is an indirect type power generation system containing three systems, that is, a primary loop coolant system, a secondary loop coolant system and a feed water and main steam system.

In the primary loop coolant system, primary liquid sodium as a primary loop coolant is heated in a core including the fissile material, located in a fast breeder reactor; the heated primary liquid sodium pressurized by a primary loop recirculation pump is introduced into an intermediate heat exchanger; the primary liquid sodium is heat-exchanged with secondary liquid sodium in the secondary loop coolant system in the intermediate heat exchanger; and the primary liquid sodium discharged from the intermediate heat exchanger is supplied into the fast breeder reactor.

In the secondary loop coolant system, the secondary liquid sodium heated by the intermediate heat exchanger and pressurized by a secondary loop recirculation pump is supplied into a steam generator; the secondary liquid sodium is heat-exchanged with feed water in the feed water and main steam system; and the secondary liquid sodium discharged from the steam generator is introduced into the intermediate heat exchanger.

In feed water and main steam system, a main steam discharged from the steam generator is introduced into high-pressure turbine and low-pressure turbine through a main steam pipe; the main steam exhausted from the low-pressure turbine is condensed and turned into water in a condenser; and the feed water discharged from the condenser is supplied into the steam generator through a feed water pipe. The feed water is pressurized by a feed water pump and heated by a feed water heater during flowing in the feed water pipe, as in the case of a boiling water reactor type nuclear power plant. A generator interlocked with the high-pressure turbine and low-pressure turbine generates electric power.

The reactor type of a general fast breeder reactor type nuclear power plant system is disclosed in a great number of nuclear power related documents as exemplified by “Basic Fast Reactor Engineering”, Nikkan Kogyo Shimbun Ltd., page 174, October, 1993. As described in this document, the fast breeder reactor type nuclear power plant system is broadly classified into two types, that is, a tank type and a loop type.

In the typical tank type fast breeder reactor nuclear power plant system, the primary loop recirculation pump and the intermediate heat exchanger are installed in a reactor vessel. This structure is capable of ensuring a compact configuration on the primary loop coolant system, and downsizing the whole reactor building. This structure also increases coolant inventory and reduces a temperature change in the transient operating mode. However, a lower portion of the intermediate heat exchanger and the primary loop recirculation pump have to be installed in a low-temperature environment in the reactor vessel and this requires installation of partition walls. Therefore, structures in the reactor vessel are complicated, and a phenomena caused in the reactor vessel tend to be complicated as well. Further, this structure increases the size of the reactor vessel, and requires particular efforts to ensure seismic resistance, and ease of production.

In the meantime, the loop type fast breeder reactor nuclear power plant provides a simple structure, as the reactor vessel, primary loop recirculation pump and intermediate heat exchanger are separately installed. The movement of coolant among various equipments and transfer of loads are carried out only through a pipe of primary loop coolant. This permits easy analysis of the phenomena and minimizes the possibility of uncertain factors being involved. Further, various equipments are highly independent of one another, and this provides easy access, and excellent maintainability and repairability. However, the installation area of the primary loop coolant system may be increased depending on how the pipes for absorbing thermal expansion of the primary loop coolant system are routed. Further, to receive sodium leaked from the pipe of primary loop coolant, installation of a sodium vessel or the like is essential. The major problem to be solved with respect to this loop type fast breeder reactor nuclear power plant is how to reduce the pipe length.

The following describes the problems to be solved for the development with reference to a loop type fast breeder reactor planned to be constructed in Japan.

FIG. 16 is a chart representing the problems to be solved for the development of a loop type fast breeder reactor. As will be apparent from the drawing, the major problems are found in three factors, that is, economy, reliability and safety (e.g. “JAEA, Research and Development for Commercialization of FBR Cycle—Start of FaCT Project—Research and Development of FBR Technology—”, J. of Nuclear Power eye, Vol. 53, No. 3, FIG. 1 of P. 26, March 2007 issue, and AESJ, Vol. 49, No. 6, pages 28-34, 2007).

The problems about economy are related to reduction of building capacity and quantity of materials, and realization of a long-term operation cycle by high burn-up. The problems with the reduction of the building capacity and the quantity of materials are found in (1) development of high chromium steel for shortening pipe, (2) adoption of a double cooling loop system for a compact system, (3) development of an intermediate heat exchanger with pump for constructing a compact primary loop coolant system, (4) constructing a compact reactor vessel, (5) development of a fuel handling system for simplification of system and (6) downsizing the containment vessel for reduction in the quantity of materials and construction period. The problem on the realization of a long-term operation cycle by high burn-up are found in (7) development of fuel cladding meeting the high burn-up requirements.

The problems on improved reliability are related to the sodium handling technique, and can be found in (8) improved measures against sodium leakage by adoption of a double pipe structure, (9) development of a straight tubular type double heat transfer tube steam generator and (10) plant designing with consideration given to maintainability and repairability.

The problems regarding enhanced safety are found in the improvement of core safety and seismic isolation techniques for a building. The problems concerning the improvement of core safety include (11) passive shutdown and cooling of the core by natural circulation, and (12) development of the technology for the prevention of re-criticality in core disruptive accidents. The problems with seismic isolation techniques for a building are related to (13) three-dimensional seismic isolation techniques for a building.

### SUMMARY OF THE INVENTION

The present invention relates to a fast breeder reactor type nuclear power plant system for implementing the “designing a double cooling loop for a compact system” as an example of reducing the building capacity and quantity of materials as the problem on economy. To be more specific, instead of a triple loop configuration for the loop coolant system disclosed in “Basic Fast Reactor Engineering”, Nikkan Kogyo Shimbun Ltd., page 174, October, 1993, a double loop configuration of the loop coolant system is required in the present invention for compact system design. This loop coolant system is an attempt for an advanced version differentiated from the triple loop for the purpose of implementing a more compact piping system. Reduction in a number of piping from three to two signifies an increase in the flow rate of the primary loop coolant for each piping, if there is no change in the flow rate of the primary loop coolant being supplied. This amounts to an increase in the average flow velocity through the piping, and a resultant increase in the problems to be solved for development. The primary loop coolant system contains two systems, that is, a hot leg wherein the high-temperature primary loop coolant prior to heat exchange flows, and a cold leg wherein the low-temperature primary loop coolant subsequent to heat exchange flows. At least one bending part is provided in order to alleviate thermal elongation resulting from the thermal expansion of the pipe, and a study is being made to devise a design method for relieving the pipe support constraint without supporting the pipe. Provision of the bending part allows the primary loop coolant system to flow locally at a high velocity. Thus, not only the swirl flow due to the normal secondary flow occurs on the downstream side of the bending part, but also separation of flow occurs on the negative side of the bending part. This may cause generation and the disappearance of vortexes to be repeated. To solve this problem, it is necessary to improve flow stability in the pipe and to enhance reliability of the pipe in order to implement a compact configuration for the system of the fast breeder reactor.

If the hot leg and cold leg as pipe of primary loop coolant for connection between the nuclear reactor and primary loop recirculation pump are provided with one or more bending parts, flow separation occurs on the downstream side of the bending part of the pipe, whereby flow instability may be caused. This flow instability causes concern in the following two points.

From the point of system performance, pressure drop of system is increased, and negative pressure occurs on the pump suction side, as viewed from the saturated pressure state, whereby cavitations may occur inside the pump.

From the point of equipment reliability, flow separation occurs on the downstream side of the bending part of the pipe. This will causes generation and disappearance of unstable vortexes to be repeated on the negative side of the downstream side of the bending part. This tends to cause pipe vibration by pressure fluctuation of flow resulting from excitation of vortexes in this system. Further, in the vicinity of the separated flow vortex, this may also cause corrosion on the inner surface of the pipe co-existing with a concentration of impurities.

As described above, to build a compact fast breeder reactor type nuclear power plant system, technological burdens are imposed on the connecting pipe of the major equipments such as a pipe of primary loop coolant. This may lead to deterioration of performance and reliability of the equipments. Further, there are similar problems with the pipe of secondary loop coolant.

The object of the present invention is provided a fast breeder reactor type nuclear power plant system provided with compact and higher performance primary and secondary loop pipes without substantially changing the building space and pipe layout space.

A feature of the present invention for attaining the above object is a fast breeder reactor type nuclear power plant system comprising: a reactor vessel provided with a core; a pipe of primary loop coolant for supplying primary loop coolant to the reactor vessel; an intermediate heat exchanger for exchanging heat of the primary loop coolant; a primary loop recirculation pump for supplying the primary loop coolant to the reactor vessel and attached to the pipe of primary loop coolant; a pipe of secondary loop coolant for circulating the secondary loop coolant through the intermediate heat exchanger; a secondary loop recirculation pump for supplying the secondary loop coolant to the intermediate heat exchanger and attached to the pipe of secondary loop coolant; a steam generator for exchanging heat using the secondary loop coolant and heating water to generate steam; a main steam pipe for supplying the steam to turbine; and a feed water pipe for supplying feed water, which is water generated by condensing the steam exhausted from turbine by a condenser, to the steam generator, wherein one or more bending parts are formed on at least the pipe of primary loop coolant of the pipes, and a part of the bending part on the downstream side is provided with a flow path having a non-circular sectional configuration wherein the negative side of the bending part is formed in either a planar or flat shape.

According to the feature of the present invention, since the average flow velocity of the coolant on the downstream side of the bending part can be reduced, generation and disappearance of hair pin type eddies at this position can be suppressed, with the result that flow stability inside the pipe is enhanced.

It is preferable to form a sectional configuration of the flow path formed on part of the bending part on the downstream side into oblong, spheroidal, square, and rectangular.

According to simulation, it has been revealed that, when the sectional configuration of the flow path formed on part of the bending part on the downstream side is designed to have the shape, the generation and disappearance of hair pin type eddies can be suppressed, as compared with the case of a circular sectional configuration, and the flow stability inside the pipe can be enhanced.

It is preferable to form only the sectional configuration of the flow path formed on part of the bending part on the downstream side into non-circular, and to form the sectional configuration of the flow path formed on other portions into circular.

Since generation and disappearance of hair pin type eddies occur within the limited range on the downstream side of the bending part, when only this position is made non-circular, the problems caused by generation and disappearance of hair pin type eddies can be improved.

It is preferable to form the sectional configuration of the entire flow path including the portion of the bending part on the downstream side into non-circular.

As described above, generation and disappearance of hair pin type eddies occurs within the limited range on the downstream side of the bending part. It is sufficient if only this position is made non-circular. However, if production is facilitated by using pipes in the same configuration from one end to the other end, it is also possible to use a pipe wherein the entire flow path is non-circular.

It is preferable to attach a reducer that is a flared or megaphone configuration wherein the diameter on an end connected to the pipe of primary loop coolant is smaller, and the diameter on another end is greater, to an inflow end of the primary loop coolant of the pipe of primary loop coolant.

According to this Structure, suction of the vertical vortex from the pipe of primary loop coolant can be suppressed by the reducer, and hence the deviation of the inflow velocity distribution in the pipe can be suppressed. Thus, generation and disappearance of hair pin type eddies on the downstream side of the bending part can be suppressed more effectively.

It is preferable to install a cross lattice for rectification in the inflow end of the primary loop coolant of the pipe of primary loop coolant.

According to this Structure, the inflow vortex at the inlet of the pipe of primary loop coolant can be disintegrated by the cross lattice for rectification. Thus, suction of the vertical vortex from the pipe of primary loop coolant and the deviation of the inflow velocity distribution can be suppressed. Accordingly, generation and disappearance of hair pin type eddies on the downstream side of the bending part can be reduced more effectively.

It is preferable to provide at least one blade type guide vane on the inner surface of the bending part.

According to this Structure, the complicated three-dimensional flow fluctuation of coolant in the bending part can be rectified correctly by one or more blade type guide vane provided on the inner surface of the bending part, and the average flow velocity can be reduced. Accordingly, generation and disappearance of hair pin type eddies on the downstream side of the bending part can be reduced more effectively.

It is preferable to form the bending part of a circular section having an inner diameter of “D” into an elbow wherein the radius R meets R/D≧1.1.

Generation and disappearance of hair pin type eddies on the downstream side of the bending part tends to occur more easily as the radius of the bending part is smaller. According to simulations, it has been revealed that, when the inner diameter of the bending part is “D”, the bending part of the circular section is formed in an elbow so that the radius R meets R/D≧1.1. This configuration has been shown to be effective in reducing the generation and disappearance of hair pin type eddies.

It is preferable to form the bending part of non-circular section having an equivalent inner diameter of “De” into an elbow wherein the radius R meets R/De≧1.1.

As described above, generation and disappearance of hair pin type eddies on the downstream side of the bending part tends to occur more easily as the radius of the bending part is smaller, as the radius of the bending part is smaller. According to simulations, it has been revealed that the bending part of a non-circular section having an equivalent inner diameter of “De” is formed in an elbow wherein the radius R meets R/De≧1.1. This configuration has been found to be effective in reducing the generation and disappearance of hair pin type eddies.

According to the fast breeder reactor type nuclear power plant system of the present invention, one or more bending parts are formed on the pipe, and a part of the bending part on the downstream side is provided with a flow path having a non-circular sectional configuration wherein the negative side of the bending part is formed in a planar or flat shape. This arrangement can reduce the average flow velocity of the coolant on the downstream side of the bending part and can suppress the generation and disappearance of hair pin type eddies in this position, with the result that flow stability inside the pipe is enhanced. Thus, this arrangement can reduce pressure drops in the system and suppress or avoid pipe vibration caused by cavitations in the pump or generation and disappearance of hair pin type eddies in the pipe, concentration of impurities on the downstream side of the bending part of the pipe, and corrosion on the inner surface of the pipe.

### BRIEF DESCRIPTION OF THE DRAWINGS

FIG. 1 is a structural diagram showing a fast breeder reactor type nuclear power plant system of one preferable embodiment of the present invention.

FIG. 2 is a sectional view taken along a line II-II of FIG. 1.

FIG. 3 is an explanatory drawing showing an outline of technological problem avoidance flow proposed in the method of the present invention in contrast to the conventional method.

FIG. 4 is an explanatory drawing showing various forms of vortexes that may occur in a hot leg connecting between a reactor vessel and primary loop recirculation pump.

FIG. 5 is an explanatory drawing showing analysis results regarding disappearance of vortexes on the downstream side of an elbow by a flat flow path of the pipe of primary loop coolant.

FIG. 6 is an explanatory drawing showing the distribution of the flow velocity on the downstream side of the elbow of the pipe of primary loop coolant.

FIG. 7 is an explanatory drawing showing frequency characteristics of hair pin type eddies produced on the downstream side of the elbow of the pipe of primary loop coolant.

FIG. 8 is an explanatory drawing showing limiting line for occurrence of various vortexes with respect to the flow velocity in the pipe and equivalent diameter.

FIG. 9 is a structural diagram showing a pipe applied to a fast breeder reactor type nuclear power plant system of another embodiment of the present invention.

FIG. 10 is a sectional view taken along a line X-X of FIG. 9 and shown various sectional configurations of the pipe shown in FIG. 9.

FIG. 11 is a structural diagram showing a pipe of primary loop coolant having a reducer installed at an inlet thereof, applied to a fast breeder reactor type nuclear power plant system of another embodiment of the present invention.

FIG. 12 is a structural diagram showing a pipe of primary loop coolant having a swirl flow preventive cross lattice installed inside an inlet thereof, applied to a fast breeder reactor type nuclear power plant system of another embodiment of the present invention.

FIG. 13 is a sectional view taken along a line XIII-XIII of FIG. 12.

FIG. 14 is a structural diagram showing a pipe of primary loop coolant having a guide vane installed inside a bending part thereof, applied to a fast breeder reactor type nuclear power plant system of another embodiment of the present invention.

FIG. 15 is an explanatory drawing showing impact of radius ratio of a bending part of a pipe of primary loop coolant, applied to a fast breeder reactor type nuclear power plant system of another embodiment of the present invention.

FIG. 16 is an explanatory drawing showing major problems with concept 13 on a fast breeder reactor of prior art.

### DETAILED DESCRIPTION OF THE PREFERRED EMBODIMENTS

The following describes one embodiment of a fast breeder reactor type nuclear power plant system of the present invention with reference to drawings.

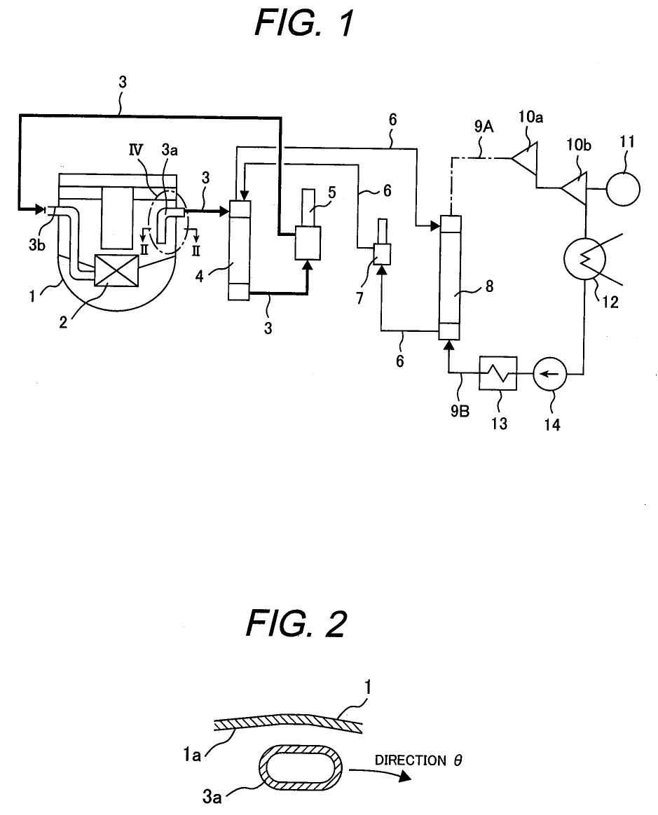

FIG. 1 shows a structural of a fast breeder reactor type nuclear power plant system. A new plant planned in Japan at present belongs to this loop type fast breeder reactor nuclear power plant system. The fast breeder reactor type nuclear power plant system is an indirect type power generation system containing a fast breeder reactor, an intermediate heat exchanger 4, a steam generator 8 and three loop coolant systems, that is, a primary loop coolant system, a secondary loop coolant system and the feed water and main steam system. The fast breeder reactor has a reactor vessel 1 and a core 2 including the fissile material, located in the reactor vessel 1.

The primary loop coolant system has a pipe 3 of primary loop coolant and a primary loop recirculation pump 5. The pipe 3 of primary loop coolant includes a hot leg 3a connecting between the reactor vessel 1 and the intermediate heat exchanger 4 and a cold leg 3b connecting between the intermediate heat exchanger 4 and the reactor vessel 1. The primary loop recirculation pump 5 is installed on the cold leg 3b.

Primary liquid sodium as a primary loop coolant heated in the core 2 is introduced into the intermediate heat exchanger 4 through the hot leg 3a by driving the primary loop recirculation pump 5. The heated primary liquid sodium is heat-exchanged with secondary liquid sodium as a secondary loop coolant in the intermediate heat exchanger 4 and thereof temperature is decreased. The primary sodium discharged from the intermediate heat exchanger 4 is supplied into the reactor vessel 1 through the cold leg 3b.

The secondary loop coolant system has a pipe 6 of secondary loop coolant and a secondary loop recirculation pump 7 installed on the pipe 6 of secondary loop coolant. The pipe 6 of secondary loop coolant is connected between the intermediate heat exchanger 4 and the steam generator 8.

The secondary liquid sodium heated by the intermediate heat exchanger is supplied to the steam generator 8 by driving the secondary loop recirculation pump 7. The secondary liquid sodium is heat-exchanged with feed water introduced into the steam generator 8. The secondary liquid sodium discharged from the steam generator 8 is returned to the intermediate heat exchanger 4.

The feed water and main steam system has a main steam system and a feed water system. The main steam system includes a main steam pipe 9A connecting between the steam generator 8 and turbines. The turbines include a high-pressure turbine 10a and a low-pressure turbine 10b. A generator 11 is interlocked with the high-pressure turbine 10a and low-pressure turbine 10b. The feed water system includes a feed water pipe 9B installing a feed water pump 14 and a feed water heater 13. The feed water pipe 9B is connected between a condenser 12 and the steam generator 8. The feed water and main steam system is as in the case of a boiling water reactor type nuclear power plant.

The steam generated in the steam generator 8 by heat-exchanging with the secondary liquid sodium and discharged from the steam generator 8 is introduced into the high-pressure turbine 10a and low-pressure turbine 10b through the main steam pipe 9A. The high-pressure turbine 10a and the low-pressure turbine 10b are rotated by the steam and the generator 11 is also rotated. The electric power is generated by the rotation of the generator 11. The steam exhausted from the low-pressure turbine 10b is condensed and turned into water by a condenser 12. The water as a feed water, discharged from the condenser 12 is supplied into the steam generator 8 through the feed water pipe 9B. The feed water is pressurized by a feed water pump 14 and heated by the feed water heater 13 during flowing in the feed water pipe 9B.

In the loop type fast breeder reactor nuclear power plant, the reactor vessel 1, the primary loop recirculation pump 5 and the intermediate heat exchanger 4 are separately installed. According to this structure, it has an advantage in that the nuclear plant is simplified and the movement of coolant among various equipments and transfer of loads are carried out only through the pipe 3 of primary loop coolant. This permits easy analysis of phenomena and minimizes the possibility of uncertain factors being involved. Further, various equipments are highly independent of one another, and this provides easy access, and excellent maintainability and repairability. Further, these cause advantages in that since the development of the system and each equipment are performed at the same time, there are not many problems with interference among the equipments, and development problems can be simplified and can be clear.

However, the installation area of the primary loop coolant system may be increased depending on how the hot leg 3a and cold leg 3b for absorbing thermal expansion of the pipe 3 of primary loop coolant are routed. To receive coolant leaked from the pipe 3 of primary loop coolant, installation of a sodium vessel or the like is essential. The major problem to be solved with respect to this loop type fast breeder reactor nuclear power plant is how to reduce the pipe length. These points are shortcomings and, at the same time, may lead to a great step forward in the development if the problems can be solved.

In the present embodiment, the sectional configuration of the hot leg 3a is designed in either a planar or flat form in the negative side of the bending part, not in the conventional circular sectional configuration. FIG. 2 shows a oblong configuration as a typical example. In this case, it is only required to locate the long side of the flat configuration so that the major diameter of the oblong configuration will be arranged in the circumferential direction θ of the inner surface 1a of the reactor vessel 1. The sectional configuration of the hot leg 3a of the pipe 3 of primary loop coolant should be designed so that the negative side of a bending part of the hot leg 3a will be formed in a planar or flat shape. As will be described later, it can be formed in oblong, spheroidal, square, rectangular, four-leafed, sectored, or hair pin-like shapes. Further, it is possible to form the sectional configuration of the flow path into the entire uniform non-circular in the flow direction of hot leg pipe 3a of primary loop coolant, and to form only part of the bending part on the downstream side into non-circular and the part of the flow path formed on other portions into circular. The non-circular pipe applied to the hot leg 3a can be used as the cold leg 3b in the same manner. Further, the non-circular pipe can also be used as the pipe for secondary loop pipe 6, the feed water pipe 9B and the main steam pipe 9A. The pressure in the reactor vessel 1 is approximately 0.3 MPa or 0.8 MPa, which is lower than that of the conventional light water reactor. This almost eliminates the technological problems of investigating the pressure resistance when using a circular pipe that can be used under high pressure.

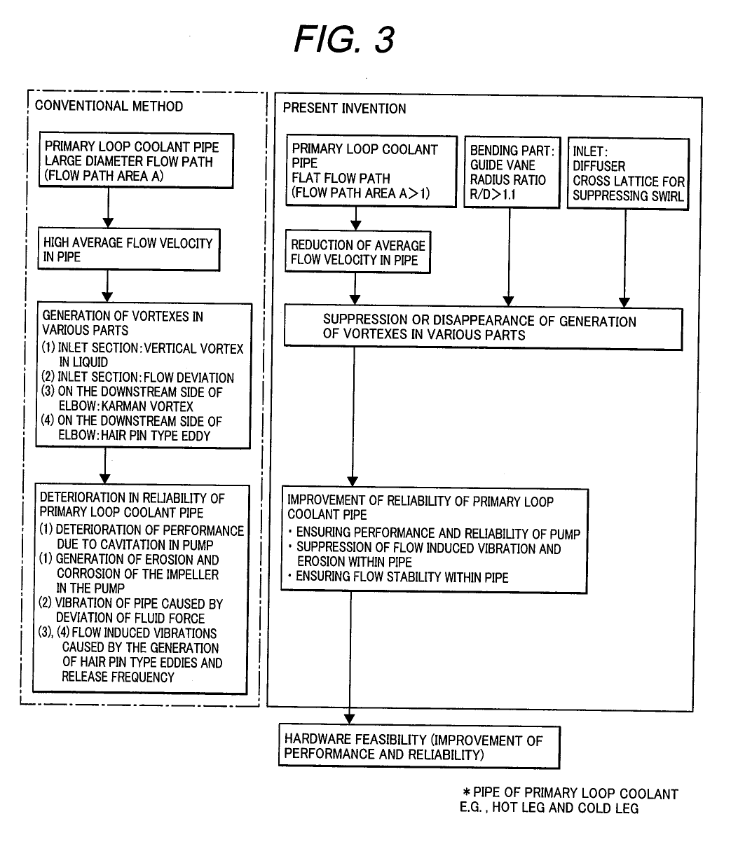

FIG. 3 shows the outline of flowcharts for investigating the avoidance measures for technological problems. An example of the flowchart for studying the avoidance measures of the prior art is shown on the left of FIG. 3, and an example of the flowchart for studying the avoidance measures of the present invention is given on the right. First, the example of the flowchart for studying the avoidance measures of the conventional will describe. Assume that the flow path area of the pipe 3 of primary loop coolant is A and a double loop of the pipe of primary loop coolant is used. By using the double loop, the average flow velocity in the pipe is increased. Thus, various forms of vortex are expected to occur at an inlet section of the pipe of primary loop coolant and on downstream side of the bending pipe of the pipe of primary loop coolant. A vertical vortex in liquid and flow deviation are anticipated to occur at the inlet section, and Karman vortexes and hair pin type eddies are estimated to occur on the downstream side of the elbow of bending part. These may reduce the reliability of the pipe of primary loop coolant. The adverse impacts based on vortexes at the inlet section include the deterioration of pump performance due to cavitations inside the pump, generation of erosion and corrosion of the impeller, and vibration of the pipe caused by deviation of hydraulic force distribution. The adverse impacts based on vortexes on the downstream side of the elbow include generation of hair pin type eddies on the downstream side of the elbow, and flow induced vibration.

By contrast, according to the example of the flowchart for studying the avoidance measures of the present embodiment, the flow path is formed to have a flat cross section throughout the pipe 3 of primary loop coolant, and flow path area A is reduced throughout the pipe 3 of primary loop coolant, whereby the average flow velocity is reduced. Further, a guide vane is installed inside the elbow, and the radius ratio R/De is set at a level greater than 1.1. This arrangement allows the equivalent diameter De to be defined by the following equation:

De=4A/Lr

wherein A denotes the sectional area of the flow path and Lr shows the wetted perimeter length. In the field of hydraulics, the equivalent diameter is called the hydraulic diameter. This is used for evaluation by replacing various shapes including triangles and spheroidal configurations with a circular pipe.

It is also possible to install an inflow reducer at the inlet or to install a cross lattice to prevent swirl flow from occurring at the time of inflow. This arrangement suppresses or prevents the aforementioned generation of vortexes at various sections, and enhances the reliability of the pipe 3 of primary loop coolant. To be more specific, the pump performance can be ensured and pump reliability can be improved by suppressing the generation of the vortexes at the inlet section, whereby vibration of the pipe due to flow or erosion can be reduced on the downstream side of the elbow. Thus, the flow stability inside the pipe can be ensured by the influence of these two factors.

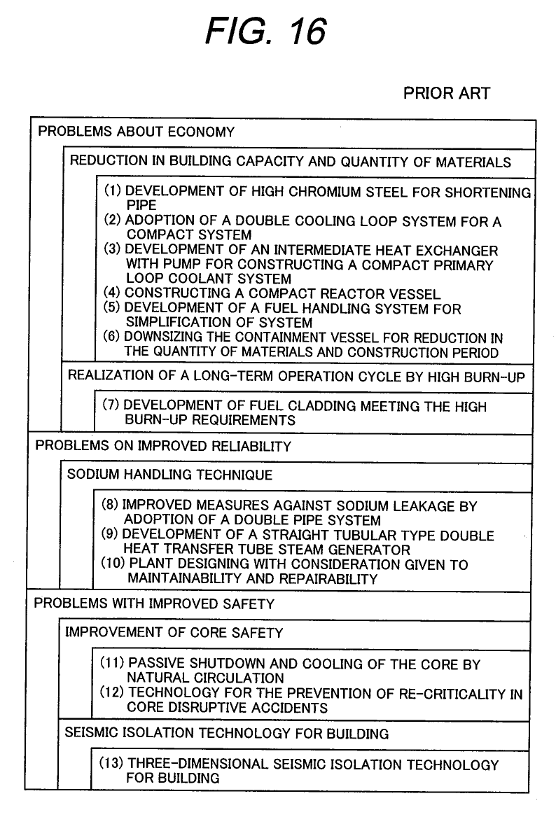

The aforementioned arrangement solves the problems shown in FIG. 16, and improves performance and reliability, and clears up problems related to feasibility of the hardware in a large-sized reactor.

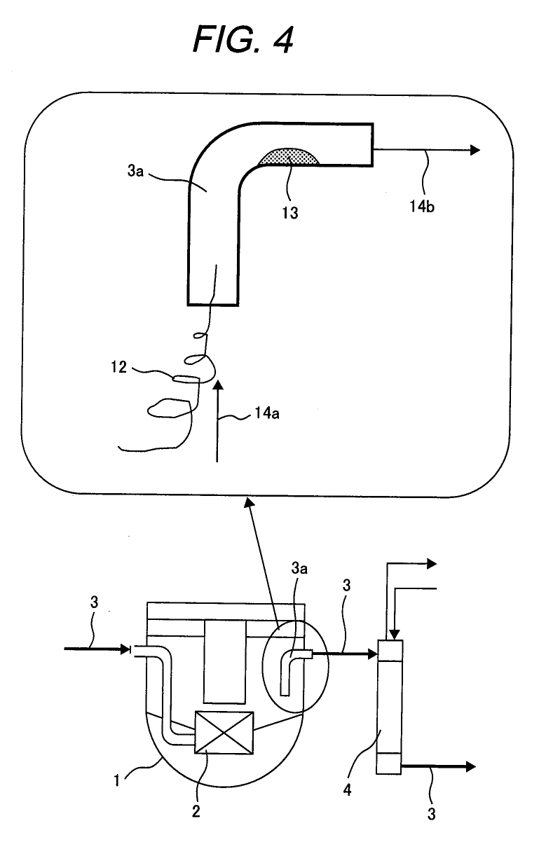

FIG. 4 shows various forms of vortexes that may occur in the pipe 3 of primary loop coolant connecting the reactor vessel 1 and primary loop recirculation pump 5. The pipe 3 of primary loop coolant will be explained with reference to the hot leg 3a that connects the reactor vessel 1 and intermediate heat exchanger 4. The vertical pipe being a part of the hot leg 3a installed in the reactor vessel 1 continues to rise until it is bent 90 degrees at a predetermined level. After that, it constitutes a horizontal pipe being a part of the hot leg 3a and the flow of the primary liquid sodium goes into the intermediate heat exchanger 4 and primary loop recirculation pump 5. An inlet section is formed at a lower portion of the vertical pipe. Before the flow goes into the primary loop recirculation pump 5, it may pass through the intermediate heat exchanger 4 or residual heat removal type heat exchanger, although this depends on the type of the system. In the case of the conventional pipe of primary loop coolant being circular pipe, vertical vortexes and flow deviation may occur at the inlet section. Further, the Karman vortexes resulting from the secondary flow caused by bending, and hair pin type eddies resulting from this Karman vortexes may occur on the downstream side of the elbow. As the pipe of primary loop coolant that connects among major equipments, this may have a serious impact on pipe vibration due to flow instability.

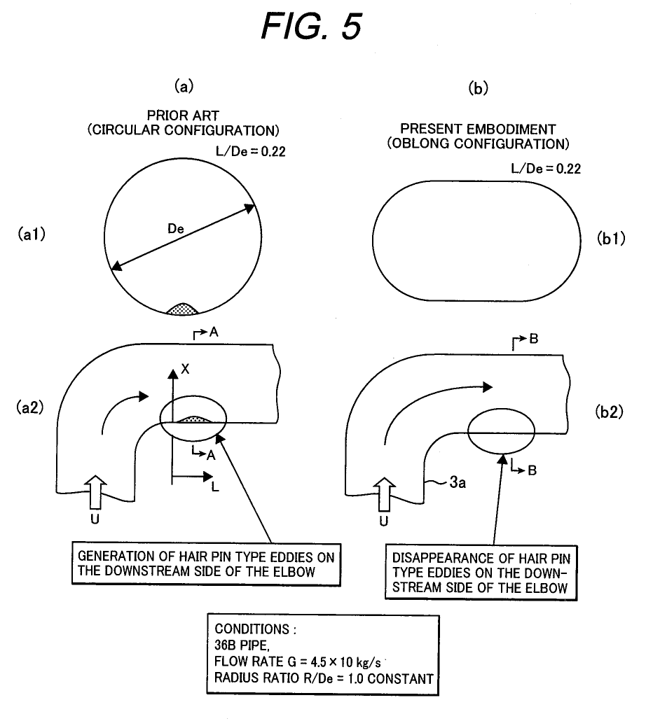

FIG. 5 shows the outline of the result of the numerical simulation regarding the presence or absence of vortexes on the downstream side of the elbow resulting from the difference in sectional configuration of the flow path in the pipe of primary loop coolant. For the purpose of investigating the disappearance of vortexes on the downstream side of the elbow due to the flat flow path, unstable flow analysis was conducted using an oblong shape as an example of the shape of a flat flow path. FIG. 5 (a1) shows a sectional configuration of a bending pipe (elbow) of prior art, taken along a line A-A of FIG. 5(a2) and FIG. 5 (b1) shows a sectional configuration of the hot leg 3a of the present embodiment, taken along a line B-B of FIG. 5(b2) (also see FIG. 2). FIG. 5(b2) shows the bending part (elbow) of this hot leg 3a. The flow path of the circular sectional configuration (a) according to the prior art is shown on the left, and the result of analyzing the flow along the oblong flow path of the present embodiment (b) is shown on the right. In this case, the analytical conditions were set as follows: the 36B pipe, constant flow rate G of the coolant come in, and the radius ratio of the bending part R/De of 1.0. On the left of the diagram showing the conventional case, irregular vortex generation was observed at the position immediately on the downstream side of the elbow (e.g., L/De=0.22), wherein “L” indicates the distance downward from the horizontal portion on the downstream side of the elbow and “De” denotes the equivalent diameter. On the right of the diagram, the vortex disappears immediately on the downstream side of the elbow. This reveals that, when the flow path is made flat, the flow coming from the secondary flow at the bending part has the effect of suppressing the separation of the vortex. Further, when the sectional area of the flow path is increased, the average flow velocity is reduced. This also has an impact to a certain extent.

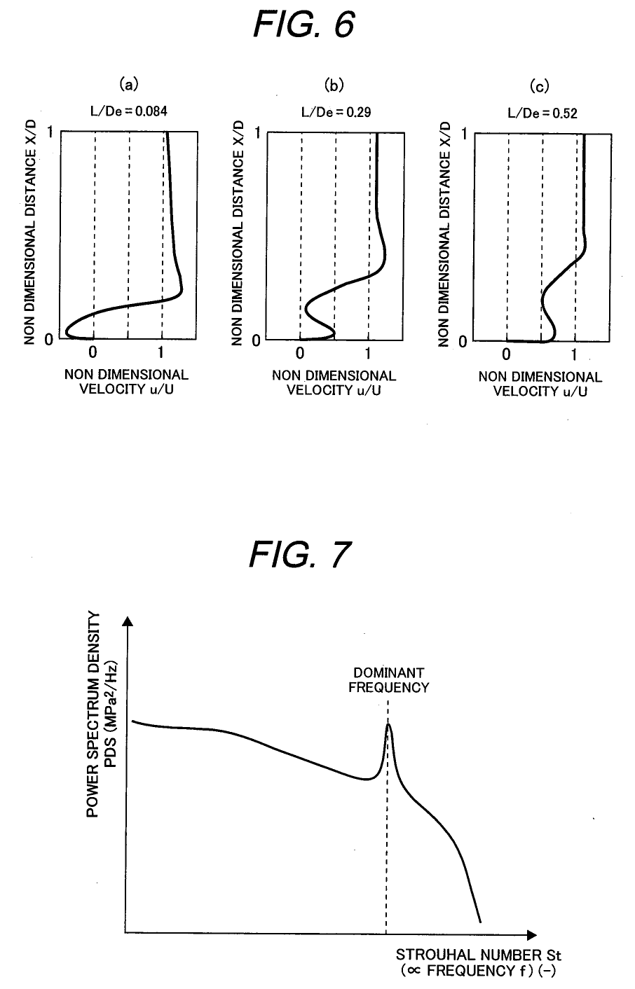

FIG. 6 shows the distribution of the flow velocity on the downstream side of the elbow of the pipe of primary loop coolant. The non-dimensional velocity u/U is plotted on the horizontal axis, and non-dimensional distance in radial direction X/De is plotted on the vertical axis. This shows the non-dimensional velocity distribution in the radial direction at various positions of the elbow pipe. In this case, “u” is the local flow velocity at the non-dimensional distance X/De, and “U” shows the average flow velocity. Further, as shown in FIG. 6, “X” shows the distance of the horizontal pipe in the radial direction on the downstream side of the elbow. (a) shown in FIG. 6 shows the case of L/De=0.084, (b) shown in FIG. 6 indicates the case of L/De=0.29, and (c) shown in FIG. 6 denotes the case of L/De=0.52. In (a), immediately on the downstream side of the elbow, a reverse flow occurs due to flow separation on the negative side, and generation of a separated flow eddy is observed. Further, as flow proceeds downstream from (b) to (c), the reverse flow caused by the separated flow is gradually recovered to the normal flow. The effect of the flow for apparent compensation from the positive sides to the negative sides resulting from the generation of three dimensional secondary flow or virtual Karman vortexes continues up to the position about one third of the distance from the negative side of the elbow to the center. As shown, the velocity distribution is not fully recovered.

FIG. 7 shows the frequency characteristics of the hair pin type eddies produced on the downstream side of the elbow of the pipe of primary loop coolant. The horizontal axis indicates frequency f or Strouhal number St (=De·f/U) as a non-dimension, and the vertical axis denotes power spectrum density. FIG. 7 shows a dominant frequency wherein the power spectrum density is increased at several tens of Hz. The dominant frequency is observed as the release frequency f of the hair pin type eddies on the downstream side of the elbow. If this is not sufficiently separated from the natural frequency of the hot leg pipe, the resonance region will be assumed, and the support requirements of the hot leg pipe will be more severe. As described above, the presence or absence of the dominant frequency is analyzed over an extensive region of operation. From the viewpoint of meeting the requirements of pressure drop and flow induced vibration finally, the operating conditions and piping design conditions must be reviewed to ensure that the resonance avoidance region can be attained by the structure of the present embodiment.

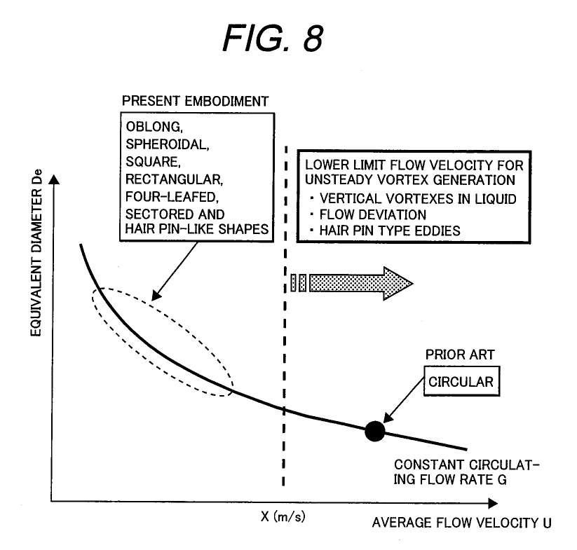

FIG. 8 is a limiting line for occurrence of various vortexes with respect to the flow velocity in the pipe and the equivalent diameter. The average flow velocity U is plotted on the horizontal axis, and the equivalent diameter De on the vertical axis. As shown in this diagram, if the circulating flow rate G is constant, it is located in the region above the lower limit flow velocity for unsteady vortex generation U=X in the conventional circular configuration. In the meantime, in the flat flow path used in one embodiment of the present invention, the equivalent diameter De is increased and the average flow velocity U is reduced. Accordingly, it is found in the region below the lower limit flow velocity limiting value for vortex generation. This is considered to cause vortexes to disappear on the downstream side of the elbow. This is because the flat sectional configuration of the flow path suppresses the flow separation caused by the spreading of the three-dimensional secondary flow, and the average flow velocity resulting from an increase in the sectional area of the flow path is reduced.

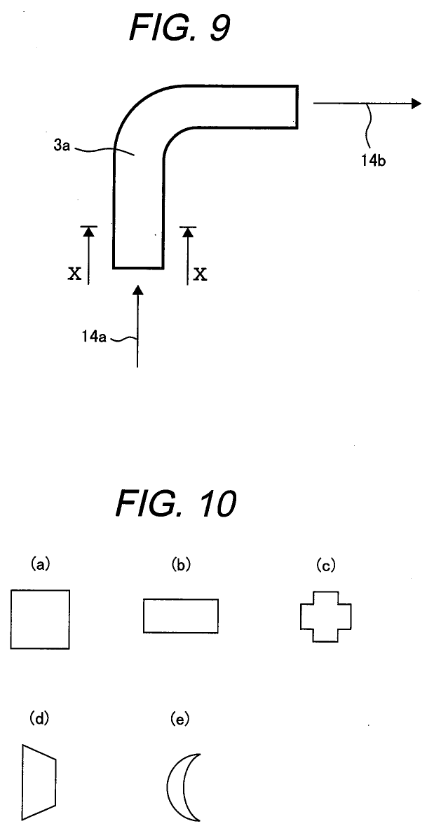

FIGS. 9, 11, 12, 14 and 15 show other embodiments of the present invention. FIG. 9 shows a sectional configuration of the flow path in the pipe 3 of primary loop coolant, applied to a fast breeder reactor type nuclear power plant system of another embodiment of the present invention. This pipe 3 of primary loop coolant has a hot leg 3a including the bending part. Flow 14a of the primary loop coolant comes in from an inlet of the hot leg 3a into the vertical pipe of the hot leg 3a. After passing through the bending part, Flow 14b of the primary loop coolant comes out from the horizontal pipe on the right.

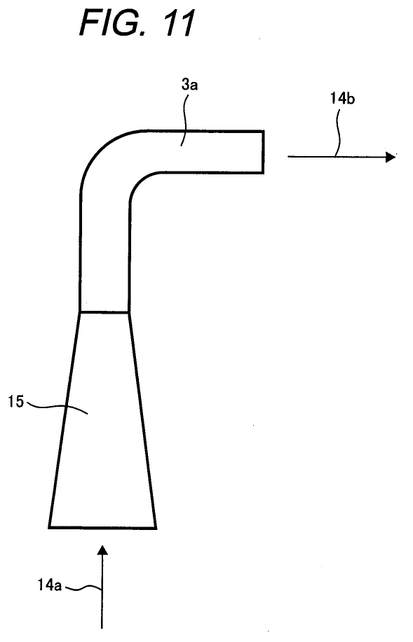

FIG. 10 shows various sectional configurations of a flow path formed in the hot leg 3a shown in FIG. 9, applied to the present embodiment. As the sectional configuration of the flow path, one of (a) Square, (b) Rectangular or Oblong, (c) Four-leafed, (d) Sectored, and (e) Hair pin-like shapes is applied. In all of these shapes, the angular positions are rounded so that the stress concentration can be relieved. It should be noted that there is no particular restriction to the aforementioned shapes if the configuration is flat.

FIGS. 11, 12, 14 and 15 illustrate various embodiments except the embodiment shown in FIG. 9. Unless otherwise specified, the members having the same reference numerals as those of FIG. 9 have the same structure and same advantages. It goes without saying that other examples are applicable to the embodiment shown in FIGS. 1 and 3.

FIG. 11 shows a reducer 15 installed at an inlet portion, which is located in the reactor vessel 1, of the pipe 3 of primary loop coolant, that is, the hot leg 3a, applied to a fast breeder reactor type nuclear power plant system of another embodiment of the present invention. The primary liquid sodium is supplied from within the reactor vessel 1 to the hot leg 3a through the reducer 15. In addition to the hot leg 3a and cold leg 3b, a great number of reactor internal structures are installed in the reactor vessel 1. Uniform sucking from the inlet of the hot leg 3a is not always ensured. Thus, the reducer 15 such as a flared pipe is attached to the lower end of the vertical pipe of the hot leg 3a to reduce the inflow velocity of the primary liquid sodium so that the primary liquid sodium will be sucked into the hot leg 3a. This structure ensures more uniform inflow than that of the prior art. The reducer 15 is arranged in the reactor vessel 1.

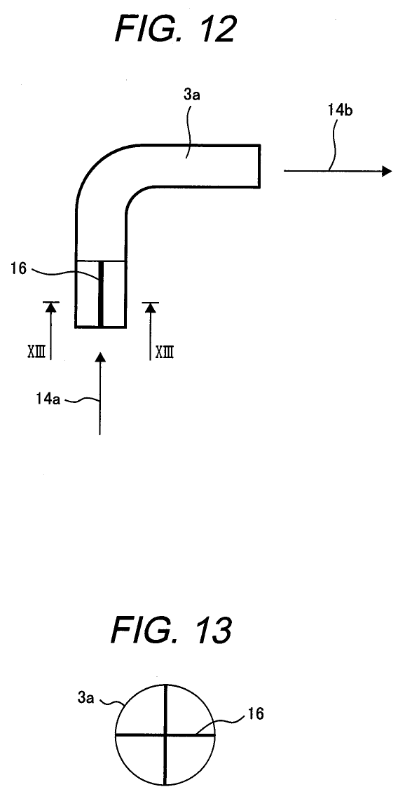

FIGS. 12 and 13 shows a lattice member 16 for preventing a swirl flow installed inside the inlet portion of the pipe 3 of primary loop coolant, that is, the hot leg 3a, applied to a fast breeder reactor type nuclear power plant system of another embodiment of the present invention. A cross configuration of the lattice member 16 is in a shape of a cross shown in FIG. 13. There is no particular restriction to the aforementioned shape of the cross if the swirl flow as a rotating flow in the circumferential direction of the pipe can be suppressed. This arrangement of the lattice member 16 prevents a swirl flow from being formed when sucked from within the reactor vessel 1 to the hot leg 3a, and suppresses the inflow of vortexes in liquid, or the generation of separation vortexes on the downstream side of the elbow.

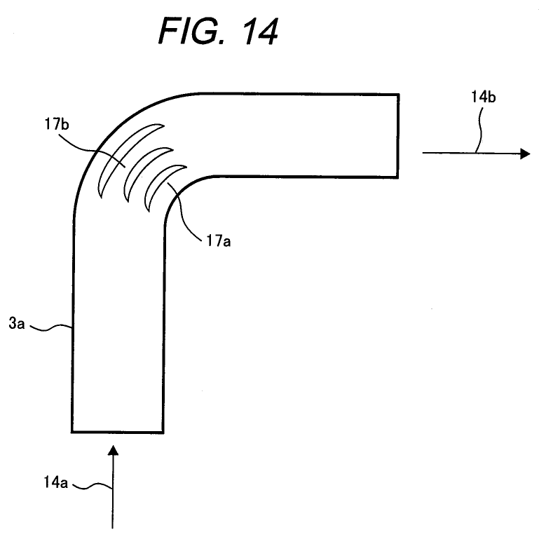

FIG. 14 shows a hot leg 3a in which a guide vane 17 is disposed, applied to a fast breeder reactor type nuclear power plant system of further another embodiment of the present invention. The guide vane 17 is disposed in the bending part of the hot leg 3a. This guide vane 17 causes the streamline induction of a flow for suppressing the secondary flow. At least one shorter guide vane 17a is installed on the negative side, and although one longer guide vane 17b is mounted on the positive side. This arrangement suppresses the generation of separated flow on the downstream side of the elbow, despite the possible occurrence of flow deviation or swirl flow on the inflow side.

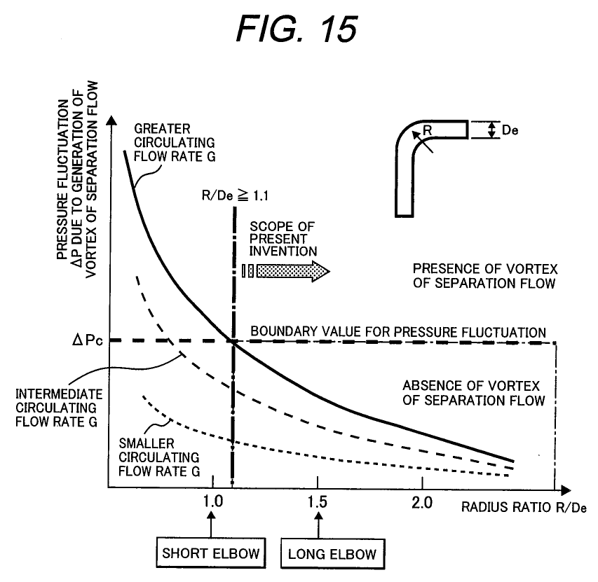

FIG. 15 shows the effect of the radius ratio R/De of the bending part of the primary loop coolant pipe in the fast breeder reactor type nuclear power plant system of further another embodiment of the present invention. The radius ratio R/De is plotted on the horizontal axis, and the pressure fluctuation characteristic due to the generation of vortex of separated flow is plotted on the vertical axis, wherein R indicates radius, and De denotes the equivalent diameter of the pipe. This diagram shows three cases, wherein the amount of primary loop coolant G is greater (U≧9 m/s), intermediate (3 m/s<U<9 m/s), and smaller (U≦3 m/s). Generally, the R/De=1.0 on the horizontal axis is called the short elbow, and the R/De=1.5 on the horizontal axis is called the long elbow. The vertical axis indicates the boundary line marking the presence or absence of the vortex of the separation flow. When the flow rate G is smaller, generation of the vortex of the separation flow cannot be observed, independently of the R/De. As the flow rate G increases, dependency on R/De increases. When the R/De increases, a gradual bent pipe is formed. This is shown to suppress the generation of separation flow. There is an effect of reducing vortex generation even when there is a great flow rate G using the R/De=1.1 as a boundary.

If the embodiment shown in FIGS. 9, 11, 12, 14 and 15 as another embodiment of the present invention are combined as required, contribution can be made to provide a still greater effect of suppressing flow induced vibration in the hot leg pipe. This combination also suppresses the reduction in thickness resulting from erosion and corrosion of the material inside the pipe in the vicinity where separation occurs.

What is claimed is:

1. A fast breeder reactor type nuclear power plant system, comprising:
a reactor vessel provided with a core;
a pipe of primary loop coolant for supplying primary loop coolant to said reactor vessel;
an intermediate heat exchanger for exchanging heat of said primary loop coolant;
a primary loop recirculation pump for supplying said primary loop coolant to said reactor vessel and attached to said pipe of primary loop coolant;
a pipe of secondary loop coolant for circulating said secondary loop coolant through said intermediate heat exchanger;
a secondary loop recirculation pump for supplying said secondary loop coolant to said intermediate heat exchanger and attached to said pipe of secondary loop coolant;
a steam generator for exchanging heat using said secondary loop coolant and heating water to generate steam;
a main steam pipe for supplying said steam to turbine; and
a feed water pipe for supplying feed water, which is water generated by condensing said steam exhausted from said turbine by a condenser, to said steam generator,
wherein one or more bending parts are formed on at least said pipe of primary loop coolant of the pipes, and a part of said bending part on downstream side is provided with a flow path having a non-circular sectional configuration wherein the negative side of said bending part is formed in either a planar or flat shape.

2. A fast breeder reactor type nuclear power plant system according to claim 1, wherein a sectional configuration of a flow path formed on part of said bending part on the downstream side is one of oblong, spheroidal, square and rectangular.

3. A fast breeder reactor type nuclear power plant system according to claim 1, wherein only a sectional configuration of a flow path formed on part of said bending part on the downstream side is non-circular, and the sectional configuration of the flow path formed on other portions is circular.

4. A fast breeder reactor type nuclear power plant system according to claim 1, wherein the sectional configuration of entire flow path including a portion of said bending part on the downstream side is non-circular.

5. A fast breeder reactor type nuclear power plant system according to claim 1, wherein an inlet end of said primary loop coolant of said pipe of primary loop coolant is provided with a reducer that is a flared or megaphone configuration wherein the diameter on side connected to said pipe of primary loop coolant is smaller than diameter on another end.

6. A fast breeder reactor type nuclear power plant system according to claim 2, wherein an inlet end of said primary loop coolant of said pipe of primary loop coolant is provided with a reducer that is a flared or megaphone configuration wherein the diameter on side connected to said pipe of primary loop coolant is smaller than diameter on another end.

7. A fast breeder reactor type nuclear power plant system according to claim 3, wherein an inlet end of said primary loop coolant of said pipe of primary loop coolant is provided with a reducer that is a flared or megaphone configuration wherein the diameter on side connected to said pipe of primary loop coolant is smaller than diameter on another end.

8. A fast breeder reactor type nuclear power plant system according to claim 4, wherein an inlet end of said primary loop coolant of said pipe of primary loop coolant is provided with a reducer that is a flared or megaphone configuration wherein the diameter on side connected to said pipe of primary loop coolant is smaller than diameter on another end.

9. A faster breeder reactor type nuclear power plant system according to claim 1, wherein a lattice member for rectification is disposed in a inlet portion of said pipe of primary loop coolant.

10. A faster breeder reactor type nuclear power plant system according to claim 2, wherein a lattice member for rectification is disposed in a inlet portion of said pipe of primary loop coolant.

11. A faster breeder reactor type nuclear power plant system according to claim 3, wherein a lattice member for rectification is disposed in a inlet portion of said pipe of primary loop coolant.

12. A faster breeder reactor type nuclear power plant system according to claim 4, wherein a lattice member for rectification is disposed in a inlet portion of said pipe of primary loop coolant.

13. A fast breeder reactor type nuclear power plant system according to claim 1, wherein at least one guide vane is provided on an inner surface of said bending part.

14. A fast breeder reactor type nuclear power plant system according to claim 2, wherein at least one guide vane is provided on an inner surface of said bending part.

15. A fast breeder reactor type nuclear power plant system according to claim 3, wherein at least one guide vane is provided on an inner surface of said bending part.

16. A fast breeder reactor type nuclear power plant system according to claim 4, wherein at least one guide vane is provided on an inner surface of said bending part.

17. A fast breeder reactor type nuclear power plant system according to claim 3, wherein said bending part of a circular section having an inner diameter of D is formed in an elbow wherein radius R meets R/D≧1.1.

18. a fast breeder reactor type nuclear power plant system according to claim 4, wherein said bending part of non-circular section having an equivalent inner diameter of De is formed in an elbow wherein radius R meets R/De≧1.1.
